(19) United States
(12) Patent Application Publication
(10) Pub. No.: US 2025/0069279 A1
(43) Pub. Date: Feb. 27, 2025

(54) IMAGE PROCESSING METHOD AND APPARATUS, AND ELECTRONIC DEVICE AND STORAGE MEDIUM

(71) Applicant: Lemon Inc., Grand Cayman (KY)

(72) Inventors: Xiang LIU, Beijing (CN); Qingyu CHEN, Los Angeles, CA (US); Xing MEI, Los Angeles, CA (US); Lexin TANG, Los Angeles, CA (US); Lingyiqing ZHOU, Los Angeles, CA (US); Lelin ZHANG, Los Angeles, CA (US)

(21) Appl. No.: 18/724,491

(22) PCT Filed: Jan. 16, 2023
(86) PCT No.: PCT/SG2023/050029

§ 371 Date: Jun. 26, 2024

(30) Foreign Application Priority Data
Jan. 24, 2022 (CN) 202210080666.7

(51) Int. Cl. G06T 11/00; G06T 5/60; G06T 5/70; G06T 7/11

(52) U.S. Cl. CPC G06T 11/00; G06T 5/60; G06T 5/70; G06T 7/11; G06T 2200/24; G06T 2207/20081; G06T 2207/20132

(57) ABSTRACT

Provided in the present disclosure are an image processing method and apparatus, and an electronic device and a storage medium. The method includes: obtaining configuration information matching effect editing in response to performing the effect editing on an initial image, wherein the configuration information includes a deep learning inference node for performing the effect editing on the initial image, and a pre-processing function node and a post-processing function node; calling processing logic of the pre-processing function node according to the configuration information to obtain input data; obtaining output data by means of an algorithm model corresponding to the deep learning inference node; and calling processing logic of the post-processing function node according to the configuration information to obtain a target image added with an effect.

### CROSS-REFERENCE TO RELATED APPLICATIONS

The present application is based on and claims priority to China Patent Application No. 202210080666.7 filed on Jan. 24, 2022, the disclosure of which is incorporated by reference herein in its entirety.

### TECHNICAL FIELD

The present disclosure relates to the field of information technology, in particular to an image processing method and apparatus, an electronic device, and a storage medium.

### BACKGROUND

As terminal and network technology continues to evolve, more and more applications adapted to terminals have emerged. For example, in image applications, various types of effect editing can be performed on initial images to add different effects in the initial images and improve the display effect of the images.

### SUMMARY

An embodiment of the present disclosure provides an image processing method, comprising: obtaining configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node; calling processing logic of the pre-processing function node based on the configuration information to transform the initial image by the processing logic of the pre-processing function node to obtain input data meeting an input requirement of an algorithm model corresponding to the deep learning inference node; performing the effect editing on the initial image based on the input data by the algorithm model corresponding to the deep learning inference node to obtain output data; and calling processing logic of the post-processing function node based on the configuration information to transform the output data by the processing logic of the post-processing function node to obtain a target image added with an effect.

An embodiment of the present disclosure further provides an image processing apparatus, comprising: an obtaining module configured to obtain configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node; a first calling module configured to call processing logic of the pre-processing function node based on the configuration information to transform the initial image by the processing logic of the pre-processing function node to obtain input data meeting an input requirement of an algorithm model corresponding to the deep learning inference node; a second calling module configured to perform the effect editing on the initial image based on the input data by the algorithm model corresponding to the deep learning inference node to obtain output data; and a third calling module configured to call processing logic of the post-processing function node based on the configuration information to transform the output data by the processing logic of the post-processing function node to obtain a target image added with an effect.

An embodiment of the present disclosure provides an electronic device, comprising: one or more processors; and a storage device configured to store one or more programs that, when executed by the one or more processors, cause the one or more processors to implement the image processing method described above.

An embodiment of the present disclosure further provides a computer-readable storage medium stored thereon a computer program that, when executed by a processor, implements the image processing method described above.

An embodiment of the present disclosure further provides a computer program, comprising: instructions that, when executed by a processor, cause the processor to perform the image processing method described above.

### BRIEF DESCRIPTION OF THE DRAWINGS

The above and other features, advantages, and aspects of the embodiments of the present disclosure will become more apparent from the following embodiments with reference to the drawings. Throughout the drawings, the same or similar reference signs indicate the same or similar elements. It should be understood that the drawings are schematic and the components and elements are not necessarily drawn to scale.

FIG. 1 is a flowchart of an image processing method in an embodiment of the present disclosure;

FIG. 2 is a schematic diagram of processing links for implementing different editing effects in an embodiment of the present disclosure;

FIG. 3 is a schematic structural diagram of an image processing apparatus in an embodiment of the present disclosure.

FIG. 4 is a schematic structural diagram of an electronic device in an embodiment of the present disclosure.

### DETAILED DESCRIPTION

Exemplary embodiments of the present disclosure will now be described in detail with reference to the accompanying drawings. Although some embodiments of the present disclosure are shown in the accompanying drawings, it should be understood that the present disclosure can be implemented in various forms, and should not be construed as being limited to the embodiments set forth herein. On the contrary, these embodiments are provided for a more thorough and complete understanding of the present disclosure. It should be understood that the drawings and embodiments of the present disclosure are only used for exemplary purposes, and are not used to limit the scope of protection of the present disclosure.

It should be understood that the various steps described in the methods of the embodiments of the present disclosure may be executed in a different order, and/or executed in parallel. In addition, the method embodiments may comprise additional steps and/or some of the illustrated steps may be omitted. The scope of the present disclosure is not limited in this regard.

The term “comprising” and its variants as used herein is an open-ended mode expression, that is, “comprising but not limited to”. The term “based on” means “based at least in part on”. The term “one embodiment” means “at least one embodiment”; the term “another embodiment” means “at least one additional embodiment”; the term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order of functions performed by these devices, modules or units, or interdependence therebetween.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

In related art, when performing a certain type of effect editing on an initial image, it is necessary to implement the effect editing through a configuration file corresponding to the type of effect editing, wherein the configuration file stores processing logic required to implement the type of effect editing. However, the inventors of the present disclosure have found that due to the similarity between different effects, there may be a lot of repetitive processing logic in the configuration files corresponding to different types of effect editing. As the number of effects increases, the existing processing methods may lead to more and more repetitive processing logic, resulting in increasing volume of an image application package. In addition, storing the complete processing logic for implementing a certain type of effect editing in each configuration file results in a large development workload, thereby reducing development efficiency.

In view of this, an embodiment of the present disclosure provides an image processing method to achieve reuse of the same processing logic when performing different effect editing on an initial image, thereby reducing the volume of the image application and improving development efficiency.

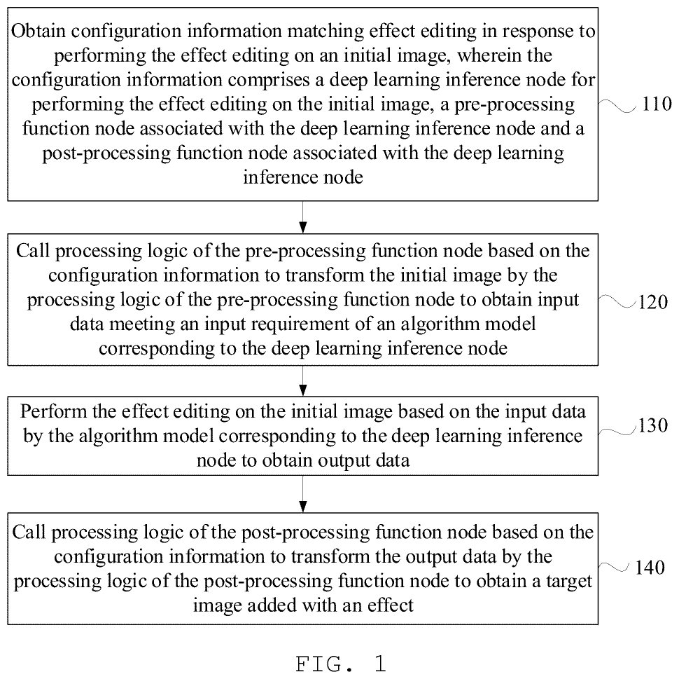

FIG. 1 is a flowchart of an image processing method in an embodiment of the present disclosure. The method can be performed by an image processing apparatus. The apparatus can be implemented in software and/or hardware. The apparatus can be configured in an electronic device, such as an terminal, comprising but not limited to an smart phone, a handheld computer, a tablet computer, a wearable device with a display screen, a desktop, a notebook computer, an all-in-one computer, a smart home device, or the like.

As shown in FIG. 1, the method comprises steps 110 to 140.

In step 110, configuration information matching effect editing is obtained in response to performing the effect editing on an initial image, wherein the configuration information comprises a deep learning inference node for performing the effect editing on the initial image, a pre-processing function node associated with the deep learning inference node and a post-processing function node associated with the deep learning inference node.

For example, the initial image can be an image frame of a video to be edited, a picture material imported by a user from a local album, or a picture material downloaded from the Internet.

A purpose of perform effect editing on the initial image can be adding some effect to the initial image to make an visual effect of the initial image better and more interesting. For example, the purpose of performing the effect editing on the initial image is to change a face of a character in the initial image to a comic face or a funny face, or to change the character's mouth to an exaggerated big mouth.

For example, a user can trigger operation of the effect editing performed on the initial image by triggering an effect control on an interface. In other words, the effect editing can correspond to a particular effect control. For example, an effect control 1 corresponds to an effect editing A, an effect control 2 corresponds to an effect editing B, and so on. When the user triggers an effect control (such as, the effect control 1), configuration information associated with the effect control is obtained. That is, the configuration information matching the effect editing A is obtained. The configuration information can be stored in the terminal or in a server.

In some embodiments, the obtaining of the configuration information matching the effect editing comprises: determining a configuration file having a preset binding relationship with the effect editing; and reading the configuration information from the configuration file.

The configuration information comprises a deep learning inference node for performing the effect editing on the initial image, a pre-processing function node associated with the deep learning inference node and a post-processing function node associated with the deep learning inference node. However, the configuration information does not comprise an algorithm model corresponding to the deep learning inference node, nor does it comprise processing logic of the pre-processing function node and processing logic of the post-processing function node. That is, the algorithm model corresponding to the deep learning inference node, the processing logic of the pre-processing function node, and the processing logic of the post-processing function node are stored separately from the configuration information. The advantage of this arrangement is that, on the one hand, it allows for the reuse of the same processing logic involved in different effect editing on the initial image; on the other hand, compared with the way that the algorithm model corresponding to the deep learning inference node, the processing logic of the pre-processing function node and the processing logic of the post-processing function node are written in the configuration information, the technical solution of the embodiment of the present disclosure can reduce the data amount of the configuration information. When there are many types of effect editing, it can reduce the overall data amount of the application and improve development efficiency.

For example, if a first effect editing is to change a character's face in the initial image to a comic face, and a second effect editing is to change a character's face in the initial image to an animal face, both of these effect editing require a same pre-processing operation on the initial image, such as identifying a region where the character's face is located in the initial image. Processing logic configured to identify a region where the character's face is located in the initial image can be abstracted as the pre-processing function node 1. In the configuration information matching the first effect editing, only a pre-processing function node 1, a deep learning inference node 2 configured to change a character's face to a comic face, and a post-processing function node 3 are recorded, without recording the processing logic of the pre-processing function node 1. Similarly, in the configuration information matching the second effect editing, only a pre-processing function node 1, a deep learning inference node 4 configured to change a character's face to an animal face, and a post-processing function node 5 are recorded, without recording the processing logic of the pre-processing function node 1. In this way, it not only reduces the data amount of the configuration information matching the first effect editing and the data amount of the configuration information matching the second effect editing, but also achieves the reuse of the processing logic of the pre-processing function node 1. In the development stage, this can reduce the development workload and is conducive to improving the development efficiency. Moreover, the processing logic of the pre-processing function node 1 can be easily maintained in a convenient and fast way, without having to modify the configuration information for each effect editing.

It should be noted that the post-processing function node 3 and the post-processing function node 5 described above may comprise the same post-processing function node, for example, a node for performing an operation such as format conversion, size scaling, rotation, or smoothing on an image.

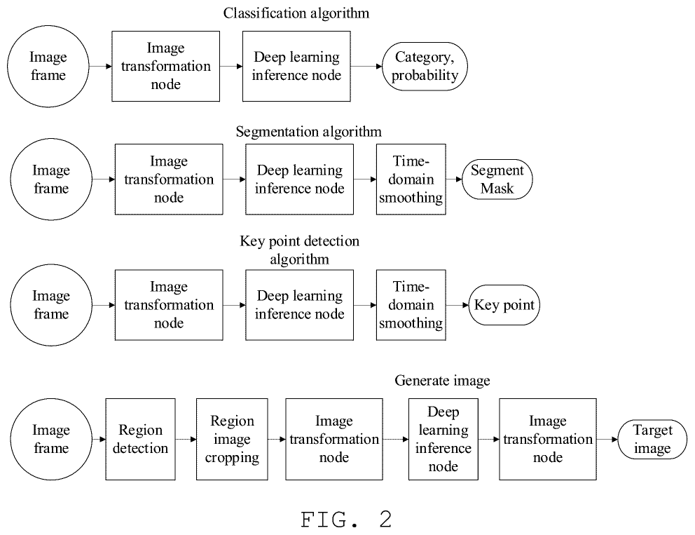

In some embodiments, pre-processing function nodes associated with different deep learning inference nodes are the same; and/or post-processing functional nodes associated with different deep learning inference nodes are the same. Accordingly, FIG. 2 shows a schematic diagram of process links for implementing different editing effects. It can be seen from FIG. 2 that the pre-processing function nodes associated with different deep learning inference nodes may be the same. For example, an image transformation node is required by the classification algorithm, the segmentation algorithm, and the key point detection algorithm.

Similarly, the post-processing functional nodes associated with different deep learning inference nodes may be the same. For example, a time-domain smoothing node is required by both the segmentation algorithm and the key point detection algorithm, wherein processing logic corresponding to the time-domain smoothing node can be configured to filter data output by the deep learning inference node to eliminate some noise.

In step 120, processing logic of the pre-processing function node is called based on the configuration information to transform the initial image by the processing logic of the pre-processing function node to obtain input data meeting an input requirement of an algorithm model corresponding to the deep learning inference node.

For example, the algorithm model corresponding to the deep learning inference node is a model for changing a character's face to a comic face, input data of the model is data of a region where the character's face is located in the initial image, which is floating-point data, so it is necessary to process the data of the initial image into floating-point data for the region where the character's face is located by the pre-processing function node. Specifically, it can be achieved by cropping the character's face in the initial image using an image cropping node (which can be understood as one of pre-processing function nodes), obtaining a local image that only comprises the character's face, calibrating the face to a center position of the local image, converting data of the local image to floating-point data by an image transformation node (which can be understood as one of pre-processing function nodes) to obtain input data that meet an input requirement of the algorithm model corresponding to the deep learning inference node.

In some embodiments, in response to the pre-processing function node comprising a plurality of nodes, the configuration information further comprises an execution sequence of the plurality of nodes. For example, both the image cropping node and the image transformation node described above belong to pre-processing function nodes, but the initial image need be processed first by the processing logic of the image cropping node and then by the processing logic of the image transformation node. That is, the execution of the image cropping node is prior to the execution of the image transformation node, and the execution sequence is identified by the data in the configuration information.

Exemplarily, the calling of the processing logic of the pre-processing function node based on the configuration information comprises: sequentially calling processing logic of the plurality nodes in the pre-processing function node according to the execution sequence.

Similarly, in response to the post-processing function node comprising a plurality of nodes, the configuration information further comprises an execution sequence of the plurality of nodes.

The calling of the processing logic of the post-processing function node based on the configuration information comprises: sequentially calling processing logic of the plurality of nodes in the post-processing function node according to the execution sequence.

For example, the pre-processing function node comprises one or more of an image transformation node, a region detection node, or a region image cropping node. The processing logic corresponding to the image transformation node is logic configured to pre-process the initial image, such as converting the data type of the initial image, obtaining an image of a specified size by scaling the initial image, or performing some noise reduction on the initial image. The processing logic corresponding to the region detection node is logic configured to determine a position of a target object (such as face, mouth, nose, or eyes, etc.) in the initial image. The processing logic corresponding to the region image cropping node is logic configured to extract the target object from the initial image.

The post-processing function node comprises one or more of the image transformation node or a time-domain smoothing node.

In step 130, the effect editing is performed on the initial image based on the input data by the algorithm model corresponding to the deep learning inference node to obtain output data.

In step 140, processing logic of the post-processing function node is called based on the configuration information to transform the output data by the processing logic of the post-processing function node to obtain a target image added with an effect.

Heretofore, an image processing method according to some embodiments of the present disclosure is provided. The method comprises: obtaining configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node; calling processing logic of the pre-processing function node based on the configuration information to transform the initial image by the processing logic of the pre-processing function node to obtain input data meeting an input requirement of an algorithm model corresponding to the deep learning inference node; performing the effect editing on the initial image based on the input data by the algorithm model corresponding to the deep learning inference node to obtain output data; and calling processing logic of the post-processing function node based on the configuration information to transform the output data by the processing logic of the post-processing function node to obtain a target image added with an effect.

That is, in the image processing method provided in the embodiment of the present disclosure, the configuration information matching each effect editing comprises only a deep learning inference node for performing the effect editing on the initial image, a pre-processing function node associated with the deep learning inference node and a post-processing function node associated with the deep learning inference node, but does not comprise the algorithm model corresponding to the deep learning inference node, and the processing logic of the pre-processing function node and the post-processing function node; the algorithm model corresponding to the deep learning inference node and the processing logic of the pre-processing function node and the post-processing function node are stored separately from the configuration information, so that when different effect editing are performed on the initial image, the same processing logic involved can be reused, thereby reducing the data amount of the configuration information matching each effect editing, further reducing the overall data amount of the image processing application, and improving development efficiency.

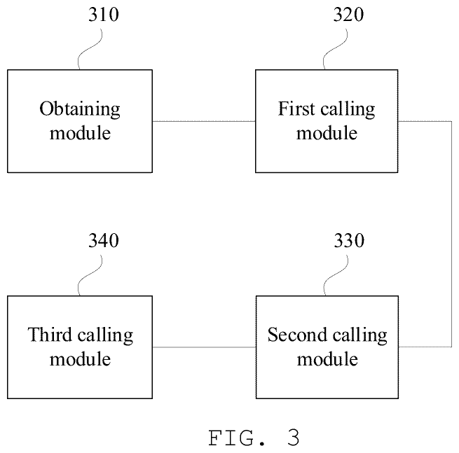

FIG. 3 is a schematic structural diagram of an image processing apparatus in an embodiment of the present disclosure. The image processing apparatus provided in the embodiment of the present disclosure can be configured in a client. The image processing apparatus comprises: an obtaining module 310, a first calling module 320, a second calling module 330, and a third calling module 340.

The obtaining module 310 is configured to obtain configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node. The first calling module 320 is configured to call processing logic of the pre-processing function node based on the configuration information to transform the initial image by the processing logic of the pre-processing function node to obtain input data meeting an input requirement of an algorithm model corresponding to the deep learning inference node. The second calling module 330 is configured to perform the effect editing on the initial image based on the input data by the algorithm model corresponding to the deep learning inference node to obtain output data. The third calling module 340 is configured to call processing logic of the post-processing function node based on the configuration information to transform the output data by the processing logic of the post-processing function node to obtain a target image added with an effect.

In some embodiments, pre-processing function nodes associated with different deep learning inference nodes are the same; and/or post-processing functional nodes associated with different deep learning inference nodes are the same.

In some embodiments, the pre-processing function node comprises a plurality of nodes, and the configuration information further comprises an execution sequence of the plurality of nodes.

In some embodiments, the first calling module 320 is configured to sequentially call processing logic of the plurality nodes in the pre-processing function node according to the execution sequence.

In some embodiments, the post-processing function node comprises a plurality of nodes, and the configuration information further comprises an execution sequence of the plurality of nodes.

In some embodiments, the second calling module 330 is configured to sequentially call processing logic of the plurality of nodes in the post-processing function node according to the execution sequence.

In some embodiments, the pre-processing function node comprises one or more of an image transformation node, a region detection node, or a region image cropping node; and the post-processing function node comprises one or more of the image transformation node or a time-domain smoothing node.

In some embodiments, the obtaining module 310 is configured to determine a configuration file having a preset binding relationship with the effect editing, and read the configuration information from the configuration file.

The image processing apparatus provided in the embodiment of the present disclosure can execute the steps executed by the client in the image processing method provided in an embodiment of the present disclosure. The steps involved and the beneficial effect achieved will not be described in detail.

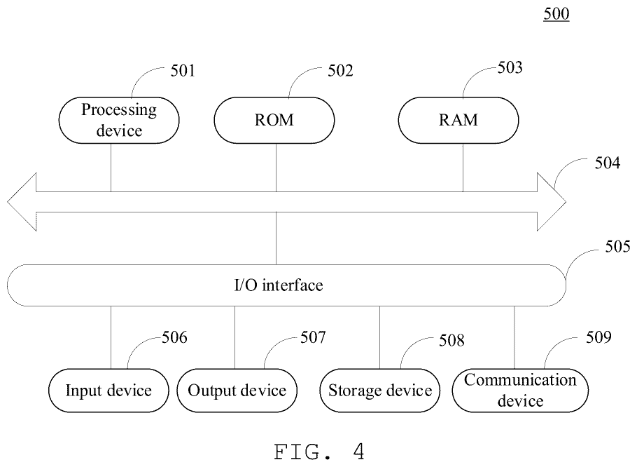

FIG. 4 is a schematic structural diagram of an electronic device in an embodiment of the present disclosure. Referring to FIG. 4, a schematic structural diagram of an electronic device 500 suitable for implementing the embodiments of the present disclosure is shown. The electronic device 500 in the embodiment of the present disclosure may comprise, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), or a wearable electronic device, and a fixed terminal such as a digital TV, a desktop computer, or a smart-home device. The electronic device shown in FIG. 4 is merely an example and should not impose any limitation on the function and scope of the embodiments of the present disclosure.

As shown in FIG. 4, the electronic device 500 may comprise a processing device (e.g., a central processing unit, a graphics processor) 501, which may perform various appropriate actions and processes to implement the image processing method of the embodiment of the present disclosure according to a program stored in Read Only Memory (ROM) 502 or a program loaded from storage device 508 into Random Access Memory (RAM) 503. In RAM 503, various programs and data required for the operation of the electronic device 500 are also stored. Processing device 501, ROM 502 and RAM 503 are connected to each other through bus 504. An input/output (I/O) interface 505 is also connected to the bus 504.

Generally, the following devices can be connected to I/O interface 505: an input device 506 comprising, for example, a touch screen, a touch pad, a keyboard, a mouse, a camera, a microphone, an accelerometer, a gyroscope, etc.; an output device 507 comprising a liquid crystal display (LCD), a speaker, a vibrator, etc.; a storage device 508 such as a magnetic tape, a hard disk, etc.; and a communication device 509. The communication device 509 enables the electronic device 500 to communicate in a wireless or wired manner with other devices to exchange data. Although FIG. 4 shows the electronic device 500 with various components, it should be understood that it is not required to implement or have all of these components. Alternatively, more or fewer components can be implemented or provided.

In particular, according to an embodiment of the present disclosure, the processes described above with reference to the flowchart can be implemented as a computer software program. For example, an embodiment of the present disclosure comprises a computer program product, which comprises a computer program carried on a non-transitory computer readable medium, and containing program code for executing the method shown in the flowchart to implement the above image processing method. In such an embodiment, the computer program may be downloaded and installed from the network through the communication device 509, or installed from the storage device 508, or from the ROM 502. When the computer program is executed by the processing device 501, the above functions defined in the method of the embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks comprise a local area network (“LAN”), a wide area network (“WAN”), the Internet, and end-to-end networks (for example, ad hoc end-to-end networks), as well as any currently known or future developed networks.

The above computer readable medium may be comprised in the electronic device described above; or it may exist alone without being assembled into the electronic device.

The computer readable medium carries one or more programs that, when executed by the electronic device, cause the electronic device to: obtain configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node; call processing logic of the pre-processing function node based on the configuration information to transform the initial image by the processing logic of the pre-processing function node to obtain input data meeting an input requirement of an algorithm model corresponding to the deep learning inference node; perform the effect editing on the initial image based on the input data by the algorithm model corresponding to the deep learning inference node to obtain output data; and call processing logic of the post-processing function node based on the configuration information to transform the output data by the processing logic of the post-processing function node to obtain a target image added with an effect.

In some embodiments, when the electronic device performs the above one or more programs, the electronic device may also perform other steps in the above embodiments.

Computer program code for performing the operations of the present disclosure may be written in one or more program design languages or a combination thereof, the program design languages comprising object-oriented program design languages, such as Java, Smalltalk, C++, etc., as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In a case of a remote computer, the remote computer may be connected to the user computer through various kinds of networks, comprising local area network (LAN) or wide area network (WAN), or connected to external computer (for example using an internet service provider via Internet).

The flowcharts and block diagrams in the drawings illustrate the architecture, functions and operations of possible implementations of systems, methods and computer program products according to various embodiments of the present disclosure. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the drawings. For example, two blocks shown in succession may be executed substantially in parallel, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. The names of the units do not constitute a limitation on the units themselves under certain circumstances.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of thereof. More specific examples of the machine-readable storage medium may comprise electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

According to one or more embodiments of the present disclosure, the present disclosure provides an image processing method, comprising: obtaining configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node; calling processing logic of the pre-processing function node based on the configuration information to transform the initial image by the processing logic of the pre-processing function node to obtain input data meeting an input requirement of an algorithm model corresponding to the deep learning inference node; performing the effect editing on the initial image based on the input data by the algorithm model corresponding to the deep learning inference node to obtain output data; and calling processing logic of the post-processing function node based on the configuration information to transform the output data by the processing logic of the post-processing function node to obtain a target image added with an effect.

According to one or more embodiments of the present disclosure, in the image processing method provided by the present disclosure, pre-processing function nodes associated with different deep learning inference nodes are the same; and/or post-processing functional nodes associated with different deep learning inference nodes are the same.

According to one or more embodiments of the present disclosure, in the image processing method provided by the present disclosure, the pre-processing function node comprises a plurality of nodes, and the configuration information further comprises an execution sequence of the plurality of nodes.

According to one or more embodiments of the present disclosure, in the image processing method provided by the present disclosure, the calling of the processing logic of the pre-processing function node based on the configuration information comprises: sequentially calling processing logic of the plurality nodes in the pre-processing function node according to the execution sequence.

According to one or more embodiments of the present disclosure, in the image processing method provided by the present disclosure, the post-processing function node comprises plurality of nodes, and the configuration information further comprises an execution sequence of the plurality of nodes.

According to one or more embodiments of the present disclosure, in the image processing method provided by the present disclosure, the calling of the processing logic of the post-processing function node based on the configuration information comprises: sequentially calling processing logic of the plurality of nodes in the post-processing function node according to the execution sequence.

According to one or more embodiments of the present disclosure, in the image processing method provided by the present disclosure, the pre-processing function node comprises one or more of an image transformation node, a region detection node, or a region image cropping node; and the post-processing function node comprises one or more of the image transformation node or a time-domain smoothing node.

According to one or more embodiments of the present disclosure, in the image processing method provided by the present disclosure, the obtaining of the configuration information matching the effect editing comprises: determining a configuration file having a preset binding relationship with the effect editing; and reading the configuration information from the configuration file.

According to one or more embodiments of the present disclosure, in the image processing method provided by the present disclosure, operation of the effect editing performed on the initial image is triggered by triggering an effect control on an interface.

According to one or more embodiments of the present disclosure, in the image processing method provided by the present disclosure, the algorithm model corresponding to the deep learning inference node, the processing logic of the pre-processing function node, and the processing logic of the post-processing function node are stored separately from the configuration information.

According to one or more embodiments of the present disclosure, in the image processing method provided by the present disclosure, the processing logic corresponding to the image transformation node is logic configured to pre-process the initial image; the processing logic corresponding to the region detection node is logic configured to determine a position of a target object in the initial image; and the processing logic corresponding to the region image cropping node is logic configured to extract the target object from the initial image.

According to one or more embodiments of the present disclosure, the present disclosure provides an image processing apparatus, comprising: an obtaining module configured to obtain configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node; a first calling module configured to call processing logic of the pre-processing function node based on the configuration information to transform the initial image by the processing logic of the pre-processing function node to obtain input data meeting an input requirement of an algorithm model corresponding to the deep learning inference node; a second calling module configured to perform the effect editing on the initial image based on the input data by the algorithm model corresponding to the deep learning inference node to obtain output data; and a third calling module configured to call processing logic of the post-processing function node based on the configuration information to transform the output data by the processing logic of the post-processing function node to obtain a target image added with an effect.

According to one or more embodiments of the present disclosure, the present disclosure provides an electronic device, comprising: one or more processors; and a storage device configured to store one or more programs that, when executed by the one or more processors, cause the one or more processors to implement the image processing method provided by any embodiment of the present disclosure.

According to one or more embodiments of the present disclosure, the present disclosure provides a computer-readable storage medium (e.g., non-transitory computer-readable storage medium) stored thereon a computer program that, when executed by a processor, implements the image processing method provided by any embodiment of the present disclosure.

According to one or more embodiments of the present disclosure, the present disclosure provides a computer program, comprising: instructions that, when executed by a processor, cause the processor to perform the image processing method provided by any embodiment of the present disclosure.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. An image processing method, comprising:
obtaining configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node;
calling processing logic of the pre-processing function node based on the configuration information to transform the initial image by the processing logic of the pre-processing function node to obtain input data meeting an input requirement of an algorithm model corresponding to the deep learning inference node;
performing the effect editing on the initial image based on the input data by the algorithm model corresponding to the deep learning inference node to obtain output data; and
calling processing logic of the post-processing function node based on the configuration information to transform the output data by the processing logic of the post-processing function node to obtain a target image added with an effect.

2. The image processing method according to claim 1, wherein:
pre-processing function nodes associated with different deep learning inference nodes are the same; and/or
post-processing functional nodes associated with different deep learning inference nodes are the same.

3. The image processing method according to claim 1, wherein the pre-processing function node comprises a plurality of nodes, and the configuration information further comprises an execution sequence of the plurality of nodes.

4. The image processing method according to claim 3, wherein the calling of the processing logic of the pre-processing function node based on the configuration information comprises:
sequentially calling processing logic of the plurality nodes in the pre-processing function node according to the execution sequence.

5. The image processing method according to claim 1, wherein the post-processing function node comprises a plurality of nodes, and the configuration information further comprises an execution sequence of the plurality of nodes.

6. The image processing method according to claim 5, wherein the calling of the processing logic of the post-processing function node based on the configuration information comprises:
sequentially calling processing logic of the plurality of nodes in the post-processing function node according to the execution sequence.

7. The image processing method according to claim 1, wherein:
the pre-processing function node comprises one or more of an image transformation node, a region detection node, or a region image cropping node; and
the post-processing function node comprises one or more of the image transformation node or a time-domain smoothing node.

8. The image processing method according to claim 1, wherein the obtaining of the configuration information matching the effect editing comprises:
determining a configuration file having a preset binding relationship with the effect editing; and
reading the configuration information from the configuration file.

9. The image processing method according to claim 1, wherein operation of the effect editing performed on the initial image is triggered by triggering an effect control on an interface.

10. The image processing method according to claim 1, wherein the algorithm model corresponding to the deep learning inference node, the processing logic of the pre-processing function node, and the processing logic of the post-processing function node are stored separately from the configuration information.

11. The image processing method according to claim 7, wherein:
the processing logic corresponding to the image transformation node is logic configured to pre-process the initial image;
the processing logic corresponding to the region detection node is logic configured to determine a position of a target object in the initial image; and
the processing logic corresponding to the region image cropping node is logic configured to extract the target object from the initial image.

12. (canceled)

13. An electronic device, comprising:
one or more processors; and
a storage device configured to store one or more programs that, when executed by the one or more processors, cause the one or more processors to:
obtain configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node;
call processing logic of the pre-processing function node based on the configuration information to transform the initial image by the processing logic of the pre-processing function node to obtain input data meeting an input requirement of an algorithm model corresponding to the deep learning inference node;
perform the effect editing on the initial image based on the input data by the algorithm model corresponding to the deep learning inference node to obtain output data; and
call processing logic of the post-processing function node based on the configuration information to transform the output data by the processing logic of the post-processing function node to obtain a target image added with an effect.

14. A non-transitory computer-readable storage medium stored thereon a computer program that, when executed by a processor, causes the processor to:
obtain configuration information matching effect editing in response to performing the effect editing on an initial image, wherein the configuration information comprises a deep learning inference node for performing the effect editing on the initial image, a pre-processing function node associated with the deep learning inference node and a post-processing function node associated with the deep learning inference node;
call processing logic of the pre-processing function node based on the configuration information to transform the initial image by the processing logic of the pre-processing function node to obtain input data meeting an input requirement of an algorithm model corresponding to the deep learning inference node;
perform the effect editing on the initial image based on the input data by the algorithm model corresponding to the deep learning inference node to obtain output data; and
call processing logic of the post-processing function node based on the configuration information to transform the output data by the processing logic of the post-processing function node to obtain a target image added with an effect.

15. (canceled)

16. The electronic device according to claim 13, wherein:
pre-processing function nodes associated with different deep learning inference nodes are the same; and/or
post-processing functional nodes associated with different deep learning inference nodes are the same.

17. The electronic device according to claim 13, wherein the pre-processing function node comprises a plurality of nodes, and the configuration information further comprises an execution sequence of the plurality of nodes.

18. The electronic device according to claim 17, wherein the one or more programs, when executed by the one or more processors, cause the one or more processors to sequentially call processing logic of the plurality nodes in the pre-processing function node according to the execution sequence.

19. The electronic device according to claim 13, wherein the post-processing function node comprises a plurality of nodes, and the configuration information further comprises an execution sequence of the plurality of nodes.

20. The non-transitory computer-readable storage medium according to claim 14, wherein:
pre-processing function nodes associated with different deep learning inference nodes are the same; and/or
post-processing functional nodes associated with different deep learning inference nodes are the same.

21. The non-transitory computer-readable storage medium according to claim 14, wherein the pre-processing function node comprises a plurality of nodes, and the configuration information further comprises an execution sequence of the plurality of nodes.

22. The non-transitory computer-readable storage medium according to claim 21, wherein the computer program, when executed by the processor, cause the processor to sequentially call processing logic of the plurality nodes in the pre-processing function node according to the execution sequence.
